(19) United States
(12) Patent Application Publication
(10) Pub. No.: US 2004/0164113 A1
(43) Pub. Date: Aug. 26, 2004

(54) Insulated carrier for wheeled vehicle

(75) Inventors: John Thomas, Brookfield, WI (US); Kyle Donovan, Milwaukee, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Milsco Manufacturing Company, a Unit of Jason Incorporated

(21) Appl. No.: 10/735,235

(22) Filed: Dec. 12, 2003

Related U.S. Application Data
(60) Provisional application No. 60/432,477, filed on Dec. 12, 2002.

(51) Int. Cl. B62J 7/00; B62J 9/00; B62J 11/00

(52) U.S. Cl. 224/413

(57) ABSTRACT

A carrier for a vehicle that includes an insulation layer disposed between an inner shell and an outer covering. The carrier shell has at least one sidewall that defines an article receiving cavity. In a preferred embodiment, insulation is applied to an exterior surface of the sidewall. In one preferred embodiment, the insulation includes heat reflecting constituents that reduce heat transfer to the shell and to an object received and supported by the shell. One preferred composition includes ceramic and/or silica particles in a binder of acrylic, epoxy and/or latex that cures to adhere to the shell. Preferred carrier embodiments include a motorcycle saddlebag, a motorcycle tour pack and a vehicle seat assembly.

### CROSS-REFERENCE TO RELATED APPLICATION

This application claims priority under 35 U.S.C. §119(e) to U.S. Provisional Patent Application No. 60/432,477, filed Dec. 12, 2002, the entire disclosure of which is incorporated herein by reference.

### FIELD OF THE INVENTION

The invention relates to a carrier used on a vehicle, and more particularly to saddlebags, tour packs, seat pans, and other carriers for vehicles, such as motorcycles and off-road vehicles.

### DESCRIPTION OF THE RELATED ART

Saddlebags and tour packs are convenience storage bags used on motorcycles as well as other mobile means. Some of these carrier designs incorporate a leather cover over a plastic shell for better looks and increased rigidity. When these are exposed to direct sunlight, particularly in warm climates, the exterior may reach temperatures up to 210° Fahrenheit and the inside compartment may reach temperatures up to 122° Fahrenheit or higher, subjecting the contents to undesirably high temperatures. Since the carrier is usually closed, substantially sealing the contents within, it is not unusual for the air inside such carriers to be stagnant and lack any convective heat transfer.

Further, certain shell materials, such as inexpensive high-density polyethylene (HDPE), distort over time due to the heat-induced contraction of the leather and expansion of the shell at these elevated temperatures. These materials take a permanent set due to the low heat deflection temperature of HDPE. For example, one such HDPE is marketed under the tradename of Paxon BA50-100 and has a heat deflection temperature of about 160° Fahrenheit when subjected to 66 psi of stress. To explain this in another way, the heat in combination with the stresses these carriers experience during use and operation often causes viscoelastic creep to unacceptably accelerate.

The combination of heat and moisture induced shrinkage of the leather exterior with the heat-induced softening of the HDPE interior can cause undesirable permanent and visible deformation of the carrier.

If desired, fillers can be added to the HDPE to increase the heat deflection temperature of the plastic, thereby helping to prevent or lessen distortion of the plastic. For example, talc is one such additive that can be added to HDPE to increase heat deflection temperature, but it does increase cost. An example of one such material is HDPE marketed under the tradename Paxon BA7794, which has a heat deflection temperature of about 210° Fahrenheit when subjected to 66 psi of stress. Unfortunately, even when such fillers are added, they do not decrease heat flux, which means they do not reduce the temperature of the article receiving and supporting part of the carrier. For example, where the carrier is a saddlebag or a tour pack, the use of HDPE containing a heat deflection temperature increasing additive, the use of such an HDPE does not decrease the temperature within its internal storage compartment.

In view of the foregoing, it would be desirable to provide a carrier, such as a motorcycle saddlebag, tour pack, or seat pan, that moderates the temperature of its article carrying and receiving compartment in a manner that can reduce deformation-causing creep and that reduces temperature of the article carrying and receiving compartment.

### SUMMARY OF THE INVENTION

The present invention is directed to a carrier for a vehicle that has a portion, preferably a compartment, that receives and supports an object. The carrier has a substrate and insulation disposed along the substrate to help reduce substrate heat buildup. In a preferred embodiment, the carrier includes a covering such that the insulation is disposed between the substrate and the covering. While the covering can be a piece of material, preferably leather, it can also be comprised of another material, such as a paint, a synthetic leather, a vinyl, a lacquer, a finish, or the like.

In one preferred embodiment, the vehicle is a motorcycle and the carrier is a saddlebag or a tour pack. The carrier has an article receiving cavity formed therein by at least one sidewall. Preferably, there are a plurality of sidewalls and end walls spaced apart so as to define the article-receiving cavity. The carrier typically includes a cap or top that overlies the cavity in a manner in which it can be at least partially removed to expose the cavity. In one preferred embodiment, the cap or top is attached by a hinge or the like that permits it to be moved from a closed position, where it completely overlies the article-receiving cavity, to an open position, where the cavity is at least partially exposed or accessible.

The sidewalls and end walls are formed by an inner shell that preferably is made of plastic. One preferred plastic material is high density polyethylene. Where the carrier is a saddlebag, the carrier preferably includes an outer covering that overlies the outer surface of the inner shell. For example, when equipped with an outer covering, the outer covering preferably overlies the outer surface of each sidewall and each end wall. In one preferred embodiment, the outer covering is a layer of material that preferably is leather or leather-like.

The insulation is disposed between the outer covering and the inner shell. In one preferred embodiment, the insulation is a layer of thin material that reduces external heat transfer to the shell. For example, where the vehicle is a motorcycle, the insulation reduces heat transfer from on-board heat sources, such as from the engine and/or exhaust system, to the shell. Additionally, the insulation also reduces heat transfer from external sources like the sun and the ground thereby reducing the temperature of the shell and the article receiving and carrying compartment formed by the shell.

One preferred insulation is made of a composition that includes silica and/or ceramic particles received in a binder that can be an acrylic binder, a latex binder, or an epoxy binder. Where such an insulation is used, it preferably is applied to one or more outer surfaces of the shell such that it adhesively bonds to the shell after curing. In one preferred embodiment, insulation is also disposed between an outer surface of the cap or top and a covering that overlies the cap or top.

In one preferred embodiment, insulation having a thickness no greater than 0.10 inch is used and the shell is kept at a temperature below that which permanent deformation occurs. In one preferred embodiment, insulation keeps the shell temperature at or below 200° Fahrenheit in the region where insulation is disposed. In another preferred embodiment, insulation keeps the shell temperature at or below 155° Fahrenheit. In another preferred embodiment, insulation is used that results in an insulation layer of about 0.016 inch thick. Preferably, heat flux is reduced by at least 20% as compared to a carrier made of a shell and outer covering that lacks insulation. In another preferred embodiment, the insulation has a thickness of between 0.10 inch and about 0.01 inch. Where an object is received and supported by the carrier, the insulation preferably keeps the object cool such that the object does not exceed a temperature of 100° Fahrenheit.

For example, in one preferred embodiment, an uninsulated saddlebag was subjected to an ambient temperature of about 110° Fahrenheit. The temperature of the internal storage compartment was as high as 122° Fahrenheit. When the aforementioned insulation was applied underneath the leather outer covering to all exterior surfaces of the saddlebag shell and its lid in a thickness that ranged from 0.015 inch to 0.040 inch, the internal compartment temperature dropped to about 95° Fahrenheit, a reduction of about 27° Fahrenheit.

In one preferred embodiment, the carrier is a motorcycle seat that is equipped with a layer of insulation to improve rider comfort by helping to keep a rider cooler. The motorcycle seat includes a substrate that is a seat pan that is made of a plastic, preferably a polyethylene, such as high density polyethylene. The seat pan supports a seat cushion thereon that includes a seat occupant supporting surface. The seat occupant supporting surface can be made of leather, synthetic leather, vinyl, or a fabric. Below the seat occupant supporting surface preferably is a layer of foam. The insulation is disposed on a top surface of the seat pan such that the insulation is disposed between the foam layer and the seat pan. Such an arrangement moderates seat occupant temperature to make it more comfortable.

Objects, features and advantages of the present invention include one or more of the following: to provide a carrier that is more dimensionally stable due to reduced heat transfer to an inner frame or core of the carrier, to provide a carrier equipped with a radiant heat deflecting layer, to provide a carrier that is equipped with a layer of insulation effective enough to reduce heat flux yet thin enough not to interfere with exterior aesthetics, to provide a carrier that is cooler and which does not viscoelastically creep, to provide a carrier that keeps objects supported thereby cooler, and to provide a carrier of durable, tough, stable, and uniform construction and which is simple and economical to make.

### BRIEF DESCRIPTION OF THE DRAWINGS

Preferred exemplary embodiments of the invention are illustrated in the accompanying drawings, in which like reference numerals represent like parts throughout and in which:

FIG. 1 is a perspective view of a carrier of this invention mounted on a motorcycle;

FIG. 2 is a perspective view of the carrier of FIG. 1 in an open position;

FIG. 3 is a perspective view of an inner plastic shell of the carrier to which insulation has been applied;

FIG. 4 is a fragmentary cross-sectional view of a preferred embodiment of the carrier of the invention;

FIG. 5 is a perspective view of the carrier with its lid disposed in a closed position;

FIG. 6. is a fragmentary cross-sectional view of a carrier of prior art construction that lacks insulation;

FIG. 7 is a perspective view of a motorcycle tour pack of the invention;

FIG. 8 is a fragmentary cross-sectional view of the tour pack that depicts the insulation layer exaggerated for clarity;

FIG. 9 is a top view of a motorcycle seat pan that is equipped with a single backrest bracket and that has the seat cushion removed for clarity;

FIG. 10 is a side view of a motorcycle seat assembly that has a pair of backrests with the seat cushion shown in phantom for clarity; and

FIG. 11 is a fragmentary cross-sectional view of the motorcycle seat assembly that depicts the insulation layer exaggerated for clarity.

It should be understood that the invention is not limited in its application to the details of construction and the arrangement of the components set forth in the drawings or in the following detailed description. Rather, the invention is capable of being practiced or carried out in various ways comprising other embodiments. It should also be understood that the phraseology and terminology employed herein is for the purpose of description and should not be regarded as limiting.

### DETAILED DESCRIPTION OF AT LEAST ONE PREFERRED EMBODIMENT

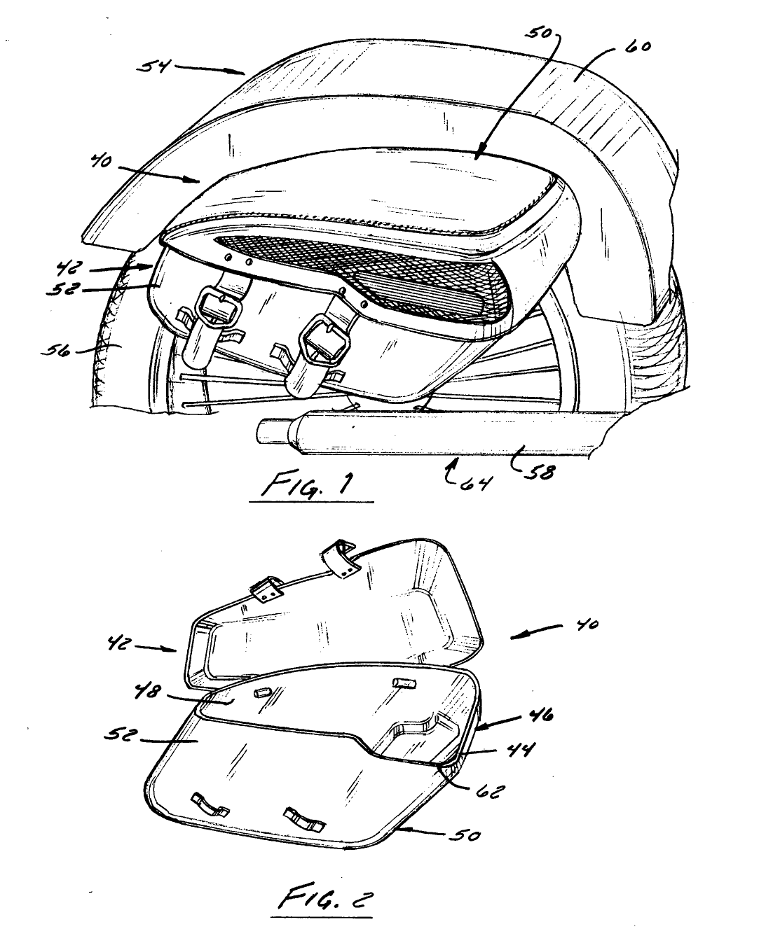

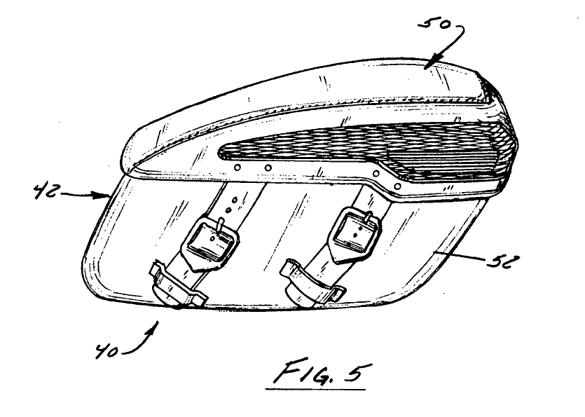

In the drawings, a preferred embodiment of a vehicle mounted, insulated carrier 40 made in accordance with the invention is depicted in FIGS. 1-5. In the preferred embodiment shown in FIGS. 1-5, the insulated carrier 40 comprises a motorcycle saddlebag 42 that is equipped with a relatively thin layer 44 of insulation 46 disposed exteriorly along an inner shell 48, which preferably is made from a plastic. In a preferred saddlebag embodiment, insulation 46 is disposed between the inner shell 48 and an outer shell covering 50. The outer covering is comprised of leather 52 that is stretched or otherwise fitted over the shell 48 in a manner that typically imparts some stress to the shell 48.

FIG. 1 illustrates a vehicle 54 that preferably is a motorcycle that is equipped with a motor (not shown) that drives one of the wheels, only a rear wheel 56 of which is shown. The carrier 40 is mounted to the motorcycle 54 in a manner in which it is securely attached. Although not shown, the carrier 40 is mounted by a bracket to part of the frame of the motorcycle 54. If desired, the carrier 40 can be mounted to the motorcycle fender 60, such as by a strap, bracket, or the like.

Where the motor is an internal combustion engine (not shown), it exhausts hot waste gases out an exhaust manifold (not shown) and through a tail pipe 58 that passes nearby the carrier 40. In the embodiment depicted in FIG. 1, the tail pipe 58 passes underneath and very close to the bottom of the carrier 40, which means that heat is transferred from the pipe 58 to the carrier 40. The insulation layer 44 helps reduce heat transfer without adding bulk to the carrier 40. As a result, carrier aesthetics are unaffected while durability and dimensional integrity are improved.

The insulation 46 moderates the temperature of the shell 48 to keep it below a temperature at which viscoelastic creep undesirably accelerates. This reduces the rate of creep such that visible deformation of the carrier 40 does not take place when the carrier 40 is left out in the sun for several hours or is put on an operating motorcycle 54 for several hours on a hot day. Preferably, such shell deformation does not take place at all, even after experiencing significant exposure to heat, including heat exposure that typically occurs when encountering any or all of the aforementioned conditions.

Where the material of the shell 48 is a plastic, such as high-density polyethylene (HDPE), the insulation 46 preferably keeps the temperature of the shell 48 below at least 155° Fahrenheit. This also advantageously helps keep the contents within the carrier 40 at or about the same temperature or even cooler. For example, in one preferred embodiment, the temperature inside the carrier 40 remains less than 100° Fahrenheit. At such lowered temperatures, the shell 48 remains cooler and thereby remains stiffer such that the stresses imparted upon it, include stresses imparted by the outer covering 50, do not distort the shell 48 and the rate of creep caused by any such stresses is reduced to an acceptable minimal level. As a result, the shell 48 remains dimensionally stable under all operating conditions and outdoor environments that a motorcycle 54 can experience. This provides increased customer satisfaction, reduced warranty costs, increased durability, and helps keeps items within any such carrier 40 at a moderate temperature of less than 100° Fahrenheit such that each such item preferably also remains dimensionally stable.

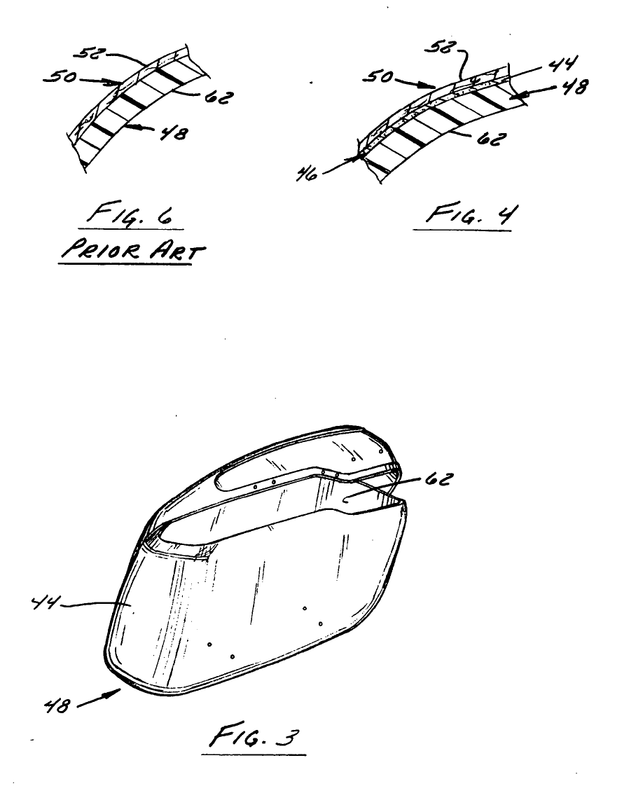

In a preferred embodiment, a layer 44 of insulation 46 covers the exterior of the carrier shell 48, such as is depicted in FIGS. 3 and 4. The insulation 46 may encompass less than the entire exterior of the shell 48 as long as insulation 46 is disposed between a heat source and the shell 48. For example, where the vehicle 54 is a motorcycle, insulation 46 is at least disposed between the carrier 40 and the motor (not shown) and/or the exhaust 58 of the motorcycle. In addition, insulation 46 preferably is also disposed between the carrier 40 and the sun.

Preferably, the outer covering 50 is in contact with the insulation 46 and the insulation 46 is in contact with the shell 48. Where the carrier 40 is a motorcycle saddlebag 42 or a tour pack (not shown), the covering 50 preferably is a leather covering 52. If desired, a shell covering made of another material can be used.

In one preferred embodiment, the insulation 46 has a thickness of between 0.005 inch (i.e., five one-thousandths of an inch) and 0.25 inch. In a currently contemplated preferred range, insulation 46 having a thickness of between about 0.01 inch and 0.10 inch is used. In a currently contemplated preferred embodiment, insulation 46 having a thickness of between about 0.01 inch and about 0.06 inch is located between a carrier shell sidewall 62 and a covering 50 overlying the sidewall 62. In a currently preferred implementation, a layer 44 of insulation 46 is applied to the exterior of the shell 48 such that the resultant insulation layer 44 has a thickness of about 0.05 inch.

In a preferred insulation embodiment, the insulation 46 is comprised of a film, a coating or a layer 44 of material that preferably self-adheres to or is carried by a carrier sidewall 62 that preferably is an exterior surface of the shell sidewall 62. If desired, such insulation 46 can be applied to the carrier outer covering 50, in addition to or instead of, the carrier shell 48.

In one preferred embodiment, the insulation 46 comprises a sprayed-on adhesive insulating coating 44 containing ceramic and/or silica particles in a ratio or composition such that heat flux is reduced by at least 20% as compared to a carrier shell not equipped with any insulation. Preferably, the insulation coating 44 has sufficient characteristics and is applied having a sufficient thickness so as to reduce heat flux to the shell by between 20% and 40% as compared to a carrier not equipped with any insulation. Preferably, the insulation has sufficient characteristics and is applied having a sufficient thickness so as to reduce the temperature of the carrier shell to a temperature below the temperature of the shell material at which a permanent deflection occurs. In a preferred embodiment, the insulation has sufficient characteristics and is applied having a sufficient thickness so as to reduce the temperature of an HDPE carrier shell to a temperature below at least about 200° Fahrenheit. Preferably, it reduces it to below about 155° Fahrenheit. Preferably, such an insulation arrangement keeps temperatures inside the inner shell of a carrier having an outer leather covering at 100° Fahrenheit or cooler.

One preferred insulation 46 is comprised of silica and/or ceramic material in a binder that can be comprised of latex, acrylic, a combination thereof, or some other binder, such as an epoxy binder or the like, that facilitates adhesion and/or cohesion to the carrier shell and/or its covering. One preferred insulating material 46 is an amorphous silica based insulation that is commercially marketed under the trade name of “Ceramic Cover” by Thermal Protective Systems, L.L.C., of 1203 Lake Street, Suite 211, of Fort Worth, Tex., 76102. Ceramic Cover comprises a mixture of amorphous silica particles received in an acrylic binder that is applied in liquid form by spraying the mixture onto the outer surface of the carrier shell 48 and/or an inner surface of the fabric covering 50. The mixture is formulated or agitated prior to application such that the ceramic and/or silica particles are relatively uniformly distributed within the binder so as to provide substantially uniform insulating characteristics in the locations where it is applied. In another method of application, the shell is dipped in a slurry of the insulating material and then allowed to dry or cure. If desired, such an insulating material can be painted on much like conventional paint is applied. This preferred insulating material performs particularly well; for example, a 0.016-inch thick layer of Ceramic-Cover outperforms 4 inches of foam insulation rated at R-20.

Another preferred insulating material 46 comprises a silica and ceramic bead based insulation that is received in a latex base with acrylic binders that is commercially marketed under the trade name of “Thermal Coat” by Northwest Dryer & Machinery Co. of 9898 SW Tigard Street, of Tigard, Oreg. 97233. In use, the insulating material 46 is sprayed on an exterior surface of a sidewall 62 of a carrier 40 of a vehicle that preferably is a motorcycle. The insulating material 46 is disposed between the carrier 40 and a heat source 64 of the vehicle, such as its engine (not shown) and/or exhaust system 58. Where the carrier 40 is equipped with a covering 50, such as for decorative purposes, the insulating material 46 is disposed between the covering 50 and the shell 48. Care should be taken to control humidity in the vicinity of the spraying and any subsequent curing or drying operation until the insulating material 46 dries. Preferably, the insulation 46 should be applied in a humidity-controlled environment. If desired, a desiccant can be used where conventional dehumidifying equipment does not lower humidity enough so as to help ensure proper drying or curing.

During operation, the insulating material 46 opposes heat passage from the heat source 64 to the carrier 40 thereby stabilizing its shape and helping it to better resist heat-related deformation. As the vehicle 54 is driven, the temperature of each of its heat sources increase, where so equipped, thereby providing an increased source of radiant and convective heat. When the vehicle 54 is stopped, the carrier 40 is subject to radiant heating from the sun as well as convective and radiant heating from each heat source 64 of the vehicle. By providing insulation 46 between each heat source, such as heat source 64 and the sun (not shown), and the carrier shell 48, less heat is transferred to the shell 48 thereby reducing the maximum temperature that it can reach. In one preferred embodiment, the insulation 46 helps conductively insulate while also blocking radiant heat. In another preferred embodiment, the primary insulating mechanism is by blocking the conduction of heat. In a still further preferred embodiment, the primary insulating mechanism is by blocking radiant heat. As a result of the carrier 40 being equipped with insulation 46, the temperature of the carrier shell 48 preferably never reaches a temperature that is 155° Fahrenheit or greater and certainly never exceeds 200° Fahrenheit.

In another preferred embodiment, the insulation layer 44 can be in the form of a paper, cloth or some other material that is sprayed-on, which is applied either on the outer shell 48 or on the inner surface of the leather covering 52. Preferably, the insulation layer 44 is a ceramic insulation that is encapsulated in a binder, such as an acrylic binder. As previously disclosed, a preferred sprayed-on material is a ceramic insulation with the trade name Ceramic Cover, but there are several other similar materials with various trade names commercially available that can also be used in accordance with the embodiments and methods disclosed above.

In one preferred embodiment, a saddlebag 42 has a relatively thin layer 44 of ceramic and/or silica based insulation 46 disposed on an exterior surface of the shell 48, which serves as the substrate upon which the insulation 46 is received. Preferably, the thin insulation layer 44 has a thickness no greater than about 0.25 times the substrate thickness where the substrate is thickest. For example, in one preferred embodiment, the insulation layer 44 is made of particles of silica and/or a ceramic that is between 0.015 inch and 0.040 inch thick and the substrate 48 is made of HDPE having a maximum thickness of 0.17 inches, resulting in an insulation layer 44 that is less than 0.25 times the maximum substrate thickness. Preferably, the saddlebag lid is covered with the same insulation having a thickness that is no greater than 0.25 times maximum lid substrate thickness.

In one preferred embodiment, the HDPE includes fillers, such as the aforementioned talc fillers, to raise the heat deflection temperature. Even despite having a raised heat deflection temperature, the layer of insulation is nonetheless used as it also helps reduce the temperature of objects within the saddlebag.

For example, in one preferred embodiment, an uninsulated saddlebag was subjected to an ambient temperature of about 110° Fahrenheit. The temperature of the internal storage compartment was as high as 122° Fahrenheit. When the aforementioned insulation was applied underneath the leather outer covering to all exterior surfaces of the saddlebag shell and its lid in a thickness that ranged from 0.015 inch to 0.040 inch, the internal compartment temperature dropped to about 95° Fahrenheit, a reduction of about 27° Fahrenheit.

FIG. 6 illustrates a cross section of a prior art saddlebag. The saddlebag has an inner shell 48 made of a HDPE and an outer covering 50 made of leather 52. There is no insulation anywhere, which sometimes results in viscoelastic creep exceeding that which is needed to maintain dimensional stability. When this happens, heat related distortion and warpage can occur, which can be permanent. As a result, the shape of the saddlebag can be permanently deformed.

Although HDPE can be used that has certain fillers that better resist viscoelastic creep, the lack of insulation does not reduce heat flux through each shell sidewall. This can undesirably cause the contents within the saddlebag to become undesirably hot, and possibly melt or otherwise deform.

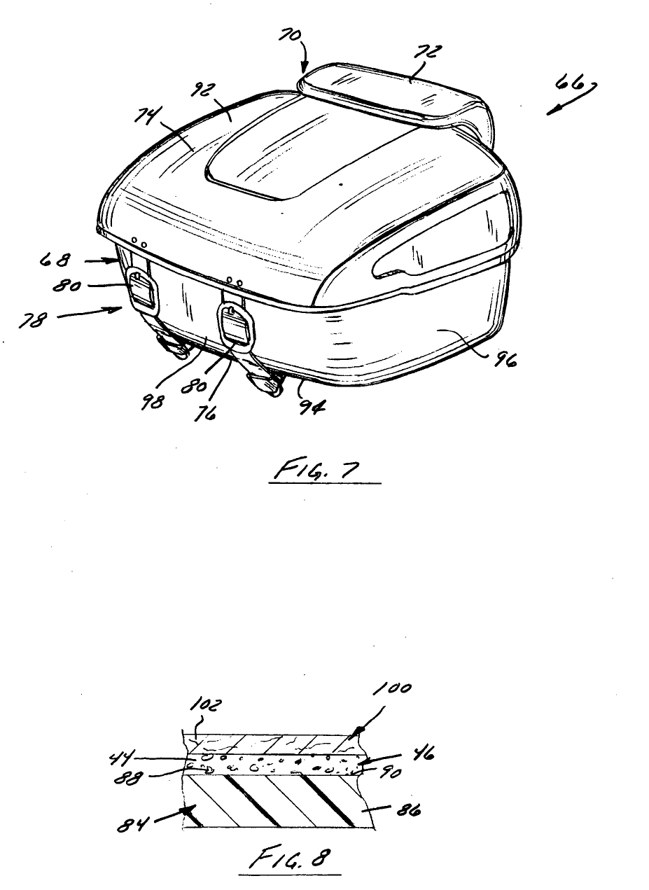

FIG. 7 illustrates a preferred embodiment of a motorcycle tour pack 66 that has a storage compartment 68 disposed rearwardly of a seat back 70 that preferably includes a seat back cushion 72. The tour pack includes a lid 74 that preferably is hingedly attached to a base 76 of the compartment by a hinge or the like (not shown). The tour pack 66 also includes a latch assembly 78 that helps keep the lid closed during use and operation. For example, the latch assembly 78 shown in FIG. 7 includes a pair of spaced apart latches 80 along the back of the tour pack. If desired, to help secure contents within the tour pack 66, the tour pack 66 can also be equipped with a locking mechanism, such as a key activated locking mechanism.

Referring additionally to FIG. 8, the tour pack 66 is made of an inner shell or tub 84 that is an HDPE substrate 86 covered by a layer 44 of insulation 46 that preferably includes silica or ceramic material 88 received in a binder 90, such as an acrylic, latex, and/or epoxy binder. The binder 90 cures to cause the insulation 46 to strongly adhere to the shell or tub 84. In this preferred embodiment, the substrate 86 preferably is three dimensionally contoured. Where insulation 46 is applied to the lid 74, the lid 74 also has a like cross-section. In one preferred embodiment, insulation 46 is applied to a top surface 92 (FIG. 7) of the lid 74 and to a bottom surface 94 (FIG. 7) of the shell or tub 84. In another preferred embodiment, insulation 46 is also applied to the sidewalls 96 and end walls 98 of the lid 74 and the shell or tub 84.

The tour pack 66 also includes an outer covering 100 that can be made of fabric or leather. In a preferred embodiment, the outer covering 100 is made of synthetic leather or leather 102. If desired, however, the outer covering 100 can be a finish that is a lacquer based finish, an epoxy based finish, or an acrylic based finish. Where such a finish is used, it preferably is advantageously directly applied over and onto the insulation 46. In fact, the insulation 46 advantageously can function as a primer for the finish.

In one preferred embodiment, a tour pack 66 has a relatively thin layer 44 of ceramic and/or silica based insulation 46 disposed on an exterior surface of the shell 84, which serves as the substrate 86 upon which the insulation 46 is received. Preferably, the thin insulation layer 44 has a thickness no greater than about 0.25 times the substrate thickness where it is thickest. For example, in one preferred embodiment, the insulation layer 44 is made of particles of silica and/or a ceramic that is between about 0.015 inch and 0.040 inch thick and the substrate 86 is made of high density polyethylene having a maximum thickness of about 0.20 inches, resulting in an insulation layer 44 that is no greater than 0.2 times the maximum substrate thickness. Preferably, the lid 74 is covered with the same insulation having a thickness that is no greater than 0.25 times maximum lid substrate thickness.

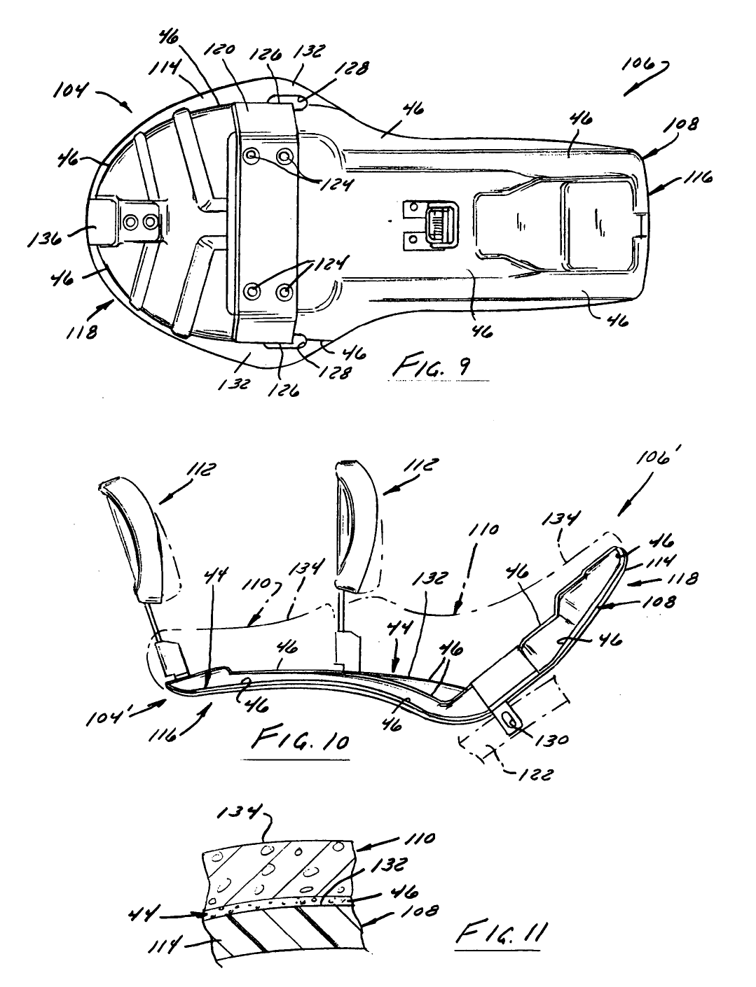

FIGS. 9 and 10 illustrate two different embodiments of a carrier 104 and 104′ that is a vehicle seat assembly 106 and 106′. In the embodiments shown in FIGS. 9 and 10, each seat assembly 106 and 106′ is a motorcycle seat assembly that includes a seat pan or seat base 108 and a seat cushion 110 (shown in FIG. 10 in phantom). If desired, the seat assembly can include one or more backrests 112. If desired, each backrest 112 can be of removable and/or adjustable construction.

The seat pan 108 includes a substrate 114 that preferably is made of a plastic, typically, HDPE. The pan 108 is three dimensionally contoured and has a tail section 116 that is disposed rearwardly toward the tail or rear end of the motorcycle to which is mounted. The pan 108 includes an enlarged forward section 118 that preferably lies just behind a gas tank (not shown) of the motorcycle.

The pan 108 is attached to part of the motorcycle. For example, as is shown in FIGS. 9 and 10, an anchor plate 120 can be used to attach at least a portion of the seat pan 108 to a chassis 122 (shown in phantom in FIG. 10) of the motorcycle. The anchor plate 120 preferably is itself attached to the pan 108. For example, as is shown in FIG. 9, two pairs of fasteners 124, each of which preferably is a rivet, is used to attach the anchor plate 120 to the pan 108.

The anchor plate 120 has a pair of mounting lugs 126 that each extends downwardly through an aperture 128 in the seat pan 108 in a manner that permits it to be attached to part of the motorcycle chassis 122. Each lug 126 has an opening 130 through which a fastener (not shown), such as a bolt, a screw, or the like, is received. To further secure the seat pan to the motorcycle, there can be a mounting tang 136, such as like that shown in FIG. 9, which engages another part of the chassis (not shown).

To help improve rider comfort, a layer 44 of insulation 46 is disposed between the upper surface 132 of the seat pan 108 and a seat occupant supporting surface 134 of the seat cushion 110. Referring additionally to FIG. 11, the insulation 46 preferably is disposed between the bottom of the seat cushion 110 and the top surface 132 of the pan 108. In one preferred implementation, the insulation 46 is bonded to the top surface 132 of the pan 108 in a manner the same as or like that previously mentioned. Insulation 46 preferably covers substantially the entire top pan surface 132, such as in the manner depicted in FIGS. 9 and 10.

In one preferred embodiment, a seat pan 108 has a relatively thin layer 44 of ceramic and/or silica based insulation 46 disposed on an exterior surface of the pan, which serves as the substrate 114 upon which the insulation 46 is received. Preferably, the thin insulation layer 44 has a thickness no greater than about 0.25 times the substrate thickness where it is thickest. For example, in one preferred embodiment, the insulation layer 44 is made of particles of silica and/or a ceramic that is between 0.015 inch and 0.040 inch thick and the substrate 114 is made of high density polyethylene having a maximum thickness of about 0.188 inches, resulting in an insulation layer 44 that is less than 0.25 times the maximum substrate thickness.

It is understood that the various preferred embodiments are shown and described above to illustrate different possible features of the invention and the varying ways in which these features may be combined. Apart from combining the different features of the above embodiments in varying ways, other modifications are also considered to be within the scope of the invention. The invention is not intended to be limited to the preferred embodiments described above.

1. A carrier for a vehicle comprising:
(a) a three dimensionally contoured plastic substrate; and
(b) insulation disposed on the three dimensionally contoured plastic substrate.

2. A vehicle carrier according to claim 1, wherein the insulation is comprised of nonmetallic particles and the insulation is adhesively attached to the plastic substrate.

3. A vehicle carrier according to claim 1, wherein the insulation has a thickness of no greater than 0.10 inch and the plastic substrate is kept at a temperature that is at or below 200° Fahrenheit due to the insulation.

4. A vehicle carrier according to claim 1, wherein the insulation is comprised of nonmetallic particles in an adhesive binder, the insulation adhesively adheres to the plastic substrate, the insulation forms a layer on the plastic substrate that is thinner than the thickness of the plastic substrate, and the insulation has a thickness of between 0.10 inch and about 0.01 inch.

5. A vehicle carrier according to claim 1, wherein the insulation is comprised of radiant heat deflecting particles received in a binder and the insulation adhesively adheres to the plastic substrate.

6. A vehicle carrier according to claim 1, wherein the insulation is comprised of radiant heat deflecting particles that prevent the plastic substrate from reaching a temperature of any greater than 155° Fahrenheit.

7. A vehicle carrier according to claim 1, wherein the plastic substrate comprises a shell of the carrier and further comprising a layer overlying the shell with the insulation disposed between the carrier and the layer.

8. A vehicle carrier according to claim 7, wherein the carrier comprises a motorcycle saddlebag and the layer overlying the shell is comprised of leather.

9. A vehicle carrier according to claim 7, wherein the carrier comprises a motorcycle tour pack.

10. A vehicle carrier according to claim 7, wherein the carrier comprises a vehicle seat assembly.

11. A vehicle carrier according to claim 7, wherein the shell is comprised of a high density polyethylene.

12. A vehicle carrier according to claim 7 wherein the insulation reduces heat flux to the shell by at least 20% as compared to a carrier having a shell and a covering with no insulation therebetween.

13. A vehicle carrier according to claim 7 wherein the insulation is comprised of an insulating material that includes at least one of a silica and a ceramic and a binder that includes at least one of an acrylic, an epoxy, and a latex.

14. A vehicle carrier according to claim 1, wherein the carrier has a portion that receives and supports an object, and wherein the insulation keeps the object at a temperature that is at or below 100° Fahrenheit due to the insulation.

15. A vehicle carrier according to claim 1, wherein the carrier has a compartment in which an object is supported and received, and wherein the insulation keeps the object in the compartment at a temperature that is at or below 100° Fahrenheit due to the insulation.

16. A carrier for a vehicle comprising:
(a) a plastic substrate;
(b) an outer covering of a flexible material; and
(c) insulation disposed between the plastic substrate and the outer covering.

17. A vehicle carrier according to claim 16, wherein the carrier comprises a saddlebag, the outer covering is comprised of leather, synthetic leather or vinyl, and the insulation is disposed between a heat source of a vehicle to which the carrier is mounted and the plastic substrate.

18. A vehicle carrier according to claim 17, wherein the vehicle comprises a motorcycle, the heat source comprises an exhaust system of the motorcycle, and the insulation is comprised of one of silica and ceramic material.

19. A vehicle carrier according to claim 17, wherein the vehicle comprises a motorcycle, the heat source comprises an exhaust system of the motorcycle, and the plastic substrate and outer covering overlie a portion of the motorcycle exhaust system.

20. A vehicle carrier according to claim 16, wherein the carrier comprises a tour pack, the outer covering is comprised of leather, synthetic leather or vinyl, the vehicle comprises a motorcycle, and the insulation is disposed between a heat source of the motorcycle to which the carrier is mounted and the plastic substrate.

21. A vehicle carrier according to claim 16, wherein the carrier comprises a vehicle seat assembly that includes a seat occupant supporting surface and a seat cushion overlying the plastic substrate, the plastic substrate comprises a three dimensionally contoured seat pan of the vehicle seat assembly, and the insulation is disposed between a seat cushion of the vehicle seat assembly and the seat pan of the vehicle seat assembly.

22. A carrier for a vehicle comprising:
(a) a plastic inner shell having a plurality of end walls and a plurality of sidewalls defining a cavity therebetween;
(b) an outer covering that covers an exterior surface of each one of the end walls and the sidewalls; and
(c) insulation disposed between the outer covering and the exterior surface of each one of the end walls and the sidewalls.

23. A vehicle carrier according to claim 22, wherein the vehicle comprises a motorcycle, the shell is comprised of a polyethylene, and the insulation is comprised of one of silica and ceramic material bonded to each exterior surface.

24. A vehicle carrier according to claim 22, further comprising a cover, an outer covering that covers an exterior surface of the cover, and insulation disposed between the cover and the outer covering.

25. A carrier for a vehicle comprising:
(a) an inner shell having at least one sidewall that defines an article holding cavity;
(b) a first outer covering that covers an exterior surface of the sidewall;
(c) a first insulation disposed between the first outer covering and the exterior surface of the sidewall;
(d) a cap that is hingedly attached to one of the inner shell and the first outer covering;
(e) a second outer covering that covers an exterior surface of the cap; and
(f) a second insulation disposed between the second outer covering and the exterior surface of the cap.

26. A carrier for a vehicle comprising:
(a) an inner shell having at least one sidewall that defines an article holding cavity;
(b) a first outer covering that covers an exterior surface of the sidewall;
(c) a first insulation disposed between the first outer covering and the exterior surface of the sidewall, wherein the first insulation is comprised of one of ceramic particles and silica particles;
(d) a cap that is hingedly attached to one of the inner shell and the first outer covering;
(e) a second outer covering that covers an exterior surface of the cap; and
(f) a second insulation disposed between the second outer covering and the exterior surface of the cap, wherein the second insulation is comprised of one of ceramic particles and silica particles.
